(19) United States
(12) Patent Application Publication
(10) Pub. No.: US 2017/0314288 A1
(43) Pub. Date: Nov. 2, 2017

(54) SUSPENDABLE STRUCTURE

(71) Applicant: Sky-Pod World Ltd., ABOYNE (GB)

(72) Inventor: Thomas Kevin LEAHY, Westcliff-On-Sea (GB)

(73) Assignee: Sky-Pod World Ltd., ABOYNE (GB)

(21) Appl. No.: 15/497,878

(22) Filed: Apr. 26, 2017

(30) Foreign Application Priority Data
Apr. 28, 2016 (GB) 1607429.6

(51) Int. Cl. E04H 15/04; E04H 15/56; E04H 15/24; E04H 15/54; E06C 1/56; E04H 15/64

(52) U.S. Cl. CPC E04H 15/04; E06C 1/56; E04H 15/64; E04H 15/24; E04H 15/54; E04H 15/56

(57) ABSTRACT

A suspendable structure 10 in the form of a suspendable tent 10 comprising of a flexible floor 12 and a network of suspension members 14, 16 for suspending the tent from a suitable suspension point. The suspendable tent 10 is conical shaped with a polygonal (or circular) floor 12. The suspendable tent 10 provides a single or sole suspension member 18 which is located at an apex 20 of the suspendable tent 10. The suspension means provides a single suspension point which solely supports and suspends the tent 10. The flooring 12 is intrinsically tensioned and an internal support strap 16 prevents the floor 12 from sagging. Accordingly, the present invention provides a suspendable tent 10 which does not require any guy ropes or other extrinsically secured tensioning and/or supporting and/or stabilising devices. The sole weight of the structure is entirely transferred through the single suspension point.

### FIELD OF THE INVENTION

The present invention relates to a suspendable structure, a method of providing a suspendable structure and a method of suspending a structure. In particular, the present invention relates to a suspendable tent, a method of providing a suspendable tent and a method of suspending a tent spaced from a ground surface.

### BACKGROUND TO THE INVENTION

Structures such as tents generally comprise a fly-sheet secured by a frame to create an internal area for a variety of uses. The frame generally comprises a rigid structure to support the fly-sheet and to create the walls and roof of the structure. The floor is generally provided by the ground surface which may be covered with a ground sheet or similar covering.

For the present purpose, the term tent is used to encompass tents with a closed fly-sheet and also tents having open canopies such as provided with a network of straps which may be used to create or represent the boundaries/walls for the structure. Furthermore, the tent may have a mesh fly-sheet and one such mesh may comprise a mosquito/insect netting to create an internal area protected from mosquitoes/insects. Accordingly, the term tent is not restricted to structures having complete and fully continuous walls and there may be areas which are entirely open, for example windows or just to provide an open, airy structure.

Such tents/shelters have a variety of uses and can be used for providing overnight accommodation or for providing temporary shelters or for more specific uses, for example bird/wildlife hides. Such shelters may also be used for concealing purposes and used by people wishing to remain hidden within an environment, for example, within a forest.

In some locations, it may be problematic to find a suitable ground surface on which to locate the tent. The ground surface may be uneven or may be unable to accept the tent pegs etc. Accordingly, the resulting tent structure will either be unstable or may be unfit for its purpose, for example sleeping on.

Suspended tents are available which may be suspended from trees or other suitable supporting locations. The suspended tent may be provided with a rigid frame to maintain the integrity of the walls of the fly-sheet. Similarly, the floor may be provided as a rigid floor such that it is strong enough to reliably retain the weight of the person(s) located within the tent.

Alternatively, a fabric floor may be provided which may provide a more compact tent which may also be portable. With such a flexible floor, there is a requirement to provide suitable tensioning within the floor and this is generally provided by guy ropes. These guy ropes must be pulled and tensioned outwardly and away from the tent in order to create a degree of tension within the floor. Accordingly, the use of guy ropes or similar tensioning systems increases the overall footprint of the tent. This means that the tent requires a suitable area with suitable supporting locations for the guy ropes. Furthermore, these guy ropes may be secured to adjacent trees or to ground pegs which again limits the location that such a tent can be used. For example, if the flooring is to be tensioned through the use of adjacent trees, then the user must first locate a tree to suspend the tent which is also surrounded by trees not too close or not too far by which the floor can be tensioned.

Alternatively, the guy ropes may be pulled outwardly down to the ground surface but this creates a hazard for those on the ground. In addition, this results in the tent no longer being relatively concealed and also relies on the ground accepting pegs through which to anchor the ends of the guy ropes.

In such suspended tents with flexible floors, the floor inevitably sags under the weight of a person and this creates a bowed shape to the floor similar to a hammock. The use of three or four tensioning guy ropes secured around the edge of the floor may provide lines of relative tension across the floor but will not create an overall tensioned floor which significantly prevents the bowing. Accordingly, the use of such suspended tents may be suitable for sitting positions for relatively short periods of time and may be suitable for outdoor seating areas or play areas for children. Such suspended tents with these flexible floors are more problematic when more than one person is located within the tent since the distribution of weight is not even and will be localised under the weight of the users.

Prior art suspended tents, therefore, do not create a good platform for sleeping purposes or for prolonged use. For example, if two people are attempting to sleep within the floor, then it is inevitable that the users will tend to move towards each other and congregate within a central area adjacent to each other.

The provision of a suitable sleeping platform may be provided through the use of a rigid floor. Tents having such rigid floors may be suitable for relatively permanent installations. However, it would not be possible for such tents to be provided as a portable unit which could easily be carried on the back of a user, for example whilst trekking.

It is an aim of the present invention to overcome at least one problem associated with the prior art, whether referred to herein or otherwise.

### SUMMARY OF THE INVENTION

According to a first aspect of the present invention there is provided a suspendable structure comprising;
a flexible floor for supporting a person thereon spaced from a ground surface;
suspension means to support the suspendable structure vertically spaced apart from the ground surface;
a peripheral support frame arranged around the flexible floor, the flexible floor being secured within the peripheral support frame and wherein the peripheral support frame is arranged to maintain tension within the flexible floor;
a plurality of flexible peripheral support members extending between the peripheral support frame and the suspension means;
the flexible floor providing an entrance region through which a person can access the suspendable structure;
an internal support means extending between the suspension means and a floor anchoring position on the flexible floor; and
wherein the floor anchoring position is located on the flexible floor at a location spaced inwardly from the periphery of the flexible floor.

Preferably the suspendable structure comprises a suspendable tent.

Preferably the flexible floor is arranged to support a number (a plurality) of persons thereon spaced from a ground surface.

Preferably the suspendable structure is portable whilst in a storage or transportable configuration. Preferably the suspendable structure is portable by a single person (one person lift) whilst in a storage or transportable configuration.

Preferably the suspendable structure is portable within a backpack whilst in a storage or transportable configuration.

Preferably the suspension means comprises a suspension member. Preferably the suspension means provides a single suspendable location for the suspendable structure.

Preferably the suspendable structure is solely supported by the suspension means.

The suspension means may comprise a suspension member. The suspension member may comprise a carabiner, a swivel connector and/or a screw-link device.

Preferably, in use, the suspendable structure is substantially conical in shape. Preferably, in use, the suspendable structure is suspended from the apex of the cone.

Preferably the peripheral support members converge towards each other upwardly from the peripheral support frame towards the suspension means.

Each peripheral support member may comprise a section of fabric (textile). Each peripheral support member may comprise a section (or length) of webbing.

The suspendable structure may comprise two, three, four, five, six, seven or eight or more individual peripheral support members.

The suspendable structure may comprise a plurality of peripheral support members wherein each peripheral support member is offset by 180° relative to the other support member within the pair. The suspendable structure may comprise two, three or more pairs of opposing peripheral support members.

The suspendable structure may comprise an odd number of peripheral support members.

The peripheral support members may be evenly arranged around the peripheral support frame and adjacent peripheral support members are preferably spaced apart by a uniform amount. The peripheral support members may be offset by an amount equal to 360 degrees divided by the number of peripheral support members. For example, three peripheral support members may be spaced apart by 120 degrees (i.e. 360°/3), four peripheral support members may be spaced apart by 90 degrees (i.e. 360°/4) and five peripheral support members may be spaced apart by 72 degrees (i.e. 360°/5) etc.

Each peripheral support member may comprise a proximal end secured to the suspension means and a distal end secured to the peripheral support frame.

Preferably the peripheral support frame comprises a rigid peripheral support frame which may comprise a plurality of peripheral support poles. The peripheral support poles may comprise arcuate peripheral support poles. The peripheral support poles may comprise straight peripheral support poles. The peripheral support poles may be connectable to each other to construct the peripheral support frame. Accordingly, the peripheral support frame may comprise a modular support frame. The peripheral support frame may comprise three, four, five, six, seven, eight or more interconnecting peripheral support poles. Preferably the peripheral frame determines the diameter of the floor region.

Preferably the peripheral support frame comprises a rigid peripheral support frame ring or hoop or comprises a rigid annular support frame.

The floor anchoring position may be substantially centrally located on the flexible floor.

The flexible floor may be substantially polygonal (or circular).

The floor anchoring position for the internal support member may be located within a central region of the polygonal (or circular) flexible floor. The floor anchoring position for the internal support member may be located within a central circular region of the polygonal (or circular) flexible floor and wherein the radius of the central circular region is less than 50% and more preferably is less than 25% of the radius of the polygonal (or circular) flexible floor.

The floor anchoring position for the internal support member may be located at the geometric centre of the polygonal (or circular) flexible floor.

The internal support means may comprise an internal support member.

Preferably the internal support member comprises a flexible section of a material (fabric or textile).

The internal support member may comprise a plurality of parallel flexible sections of material. The parallel sections may be connected together by lateral sections. The lateral sections may provide step portions to create a ladder for a person to climb on. The lateral sections may comprise spreader bars.

The internal support member may comprise one or more sections (or lengths) of webbing.

The internal support member may comprise a single securement end at a proximal end and a single anchoring end at a distal end. The internal support member may comprise a single or double securement end at a proximal end which may be tensioned or adjusted independently. The internal support member may comprise a single or double anchoring end at a distal end which may be tensioned or adjusted independently.

The internal support member may provide securement means to enable access apparatus to be secured therefrom. In particular, an access ladder may be secured from the internal support member. The securement means may comprise one or more securement members which may be in the form of loops or rings. The or each securement member may be arranged, in use, to locate in an internal space in the suspendable structure. The or each securement member may be arranged, in use, to locate at a position spaced from the flexible floor and preferably vertically above the flexible floor and preferably also within the suspendable structure. The internal support member may comprise a length adjusting device (or devices) which locate between the (or each) securement member and the floor. An external access ladder may be attached and detached directly to and from the internal support member.

The polygonal (or circular) floor may comprise a webbing matrix.

The webbing matrix may comprise a plurality of sections of webbing. The webbing matrix may comprise a plurality of sections of webbing which may be tensioned by tensioning adjustment means.

The webbing matrix may comprise a plurality of concentric lengths of webbing in varying circumferences or diameters within the flexible floor.

The webbing matrix may comprise a plurality of polygonal (or circular) sections of webbing and each may be arranged in a concentric pattern. The webbing matrix may comprise two, three, four or five polygonal (or circular) sections of webbing each being arranged in a concentric pattern.

The webbing matrix may comprise a plurality of radial sections of webbing. The radial sections of webbing may extend between an inner polygonal (or circular) section of webbing and an outer polygonal (or circular) section of webbing and these radial sections of webbing may connect each individual polygonal (or circular) webbing section.

The webbing matrix may comprise a number of adjustable webbing sections extending radially across a part of the radius of the polygonal (or circular) floor. Proximal ends of these adjustable webbing sections may be connected to an inner polygonal (or circular) section of webbing and distal ends of these adjustable webbing sections may be connected to a part of a flooring surface.

The webbing matrix may comprise a number of adjustable webbing sections extending across the diameter of the polygonal (or circular) floor. Proximal ends and distal ends of these adjustable lengths of webbing may be connected to a part of a flooring surface.

The flooring surface may comprise a mesh or section of fabric. The tension within the diametrically extending sections of webbing may be adjustable in order to increase the tension within the flooring surface.

The flexible floor may include an entrance region comprising a door. The entrance section may enable a person to enter and/or exit the suspendable structure.

The flexible door may be located offset from the centre of the (polygonal (or circular)) flexible floor. The flexible door may be provided on a sector of the polygonal (or circular) flexible floor. The flexible door may comprise an annular sector of the polygonal (or circular) flexible floor.

The flexible door may be centrally located on the (polygonal (or circular)) flexible floor. The flexible door may provide a substantially isosceles trapezium/trapezoid entrance region.

Preferably the door forms a part of the flexible floor and wherein the door, when closed and secured, provides a load bearing portion of the floor such that the floor provides a single contiguous tensioned surface when the door is in a closed configuration.

The entrance may provide a disconnecting length around a part of a periphery thereof. The disconnecting length may comprise a zipped or buckled closure mechanism.

A separation distance between the suspension means (or a suspension point) and the flexible floor may be adjusted through the adjustment of the length of the internal support member. Accordingly, the suspendable tent may be reconfigurable to provide a suspendable tent having a variety of heights. A separation distance between the suspension means (or a suspension point) and the flexible floor may be adjusted through the adjustment of the lengths of the peripheral support members and/or the internal support member.

The suspendable structure may comprise a shielding (retaining) section located around a lower height thereof. The shielding section may be provided around a lower periphery of the suspendable structure. The shielding section may be arranged to prevent people and/or objects from inadvertently falling from the flexible floor out of a side of the suspendable structure. The shielding section may provide a support section to enable a person(s) to rest against whilst sitting within the suspendable structure.

The support structure may comprise a retaining frame. The retaining frame may comprise a rigid frame and preferably comprises a rigid circular frame.

Preferably the retaining frame comprises a rigid peripheral retaining frame which may comprise a plurality of peripheral retaining poles. The peripheral retaining poles may comprise arcuate peripheral retaining poles. The peripheral retaining poles may comprise straight peripheral retaining poles. The peripheral retaining poles may be connectable to each other to construct the peripheral retaining frame. Accordingly, the peripheral retaining frame may comprise a modular retaining frame. The peripheral retaining frame may comprise 3, 4, 5, 6, 7, 8 or more interconnecting peripheral retaining poles. Preferably the retaining frame determines the diameter of the suspended structure at a specific height above the floor region.

The rigid circular frame is arranged to be spaced vertically from the peripheral support frame, in use. A partial wall (shielding section) is arranged to extend between the peripheral support frame and the retaining frame. The peripheral wall may be tensioned through tensioning means. The peripheral wall may be arranged to prevent a person(s) and/or items falling from within the suspendable structure.

The peripheral wall may provide sections which can be secured independently and opened or raised independently or as a whole (every section).

The suspendable structure may comprise lateral support members which extend around the periphery of the suspendable structure. Preferably the suspendable structure comprises two lateral support members. The lateral support members may comprise sections of webbing which extend around the periphery of the suspendable structure in a spaced apart configuration. The lateral support members may be concentric support members and these may be spaced apart along the outer conical surface or outer conical periphery of the suspendable structure. The lateral support members may comprise a (rigid) retaining frame which may be constructed from a number of sections.

The suspendable structure may comprise a fly-sheet (or canopy) to create an outer wall for the suspendable structure. The fly-sheet may comprise a textile fly-sheet. The suspendable structure may comprise a separate floor canopy/fly-sheet with an entry hatch and preferably a zipped entry hatch.

The suspendable structure may comprise a mesh fly-sheet which may comprise a mosquito net fly-sheet.

The suspendable structure may comprise an inner fly-sheet/tent (e.g. mosquito netting) and an outer fly-sheet/tent (e.g. textile/fabric) and may comprise a floor canopy/fly-sheet. The suspendable structure may comprise a 3D camouflage cover.

The flysheet may be configurable between a closed position and an open position. The flysheet may be arranged to be raised to a fully open position and secured by securement means (which may be in the form of a shock cord retention system). The flysheet (in an open position) may create a layered parasol shade overhead.

According to a second aspect of the present invention there is provided a method of providing a suspended structure comprising suspending a suspendable structure, the suspendable structure comprising;
a flexible floor for supporting a person thereon spaced from a ground surface;
suspension means to support the suspendable structure vertically spaced apart from the ground surface;
a peripheral support frame arranged around the flexible floor, the flexible floor being secured within the peripheral support frame and wherein the peripheral support frame is arranged to maintain tension within the flexible floor;
a plurality of flexible peripheral support members extending between the peripheral support frame and the suspension means;
the flexible floor providing an entrance region through which a person can access the suspendable structure;
an internal support means extending between the suspension means and a floor anchoring position on the flexible floor; and
wherein the floor anchoring position is located on the flexible floor at a location spaced inwardly from the periphery of the flexible floor.

Preferably the method comprises supporting one or more persons on the flexible floor spaced from the ground surface.

The method may comprise suspending the suspendable structure from a single or sole suspension point.

The method may comprise suspending the suspendable structure from a tree or other suitable hanging/suspension point.

### BRIEF DESCRIPTION OF THE DRAWINGS

The present invention will now be described, by way of example only, with reference to the drawings that follow, in which:

FIG. 1 is a front view of a preferred embodiment of a suspendable tent in accordance with the present invention.

FIG. 2 is an underneath view of a preferred embodiment of a suspendable tent in accordance with the present invention.

FIG. 3 is a front schematic view of a preferred embodiment of a suspendable tent in accordance with the present invention including a representation of a person to demonstrate the dimensions.

FIG. 4a is a plan view of a flooring area of a preferred embodiment of a suspendable tent in accordance with the present invention including two sleeping bags to demonstrate the dimensions and are not part of the structure.

FIG. 4b is a view of a door closing mechanism of a preferred embodiment of a suspendable tent in accordance with the present invention.

FIG. 5a is a front view of a lower distal end of an internal support member of a preferred embodiment of a suspendable tent in accordance with the present invention.

FIG. 5b is a front view of an adjustment mechanism of an internal support member of a preferred embodiment of a suspendable tent in accordance with the present invention.

FIG. 6 is a front view of a preferred embodiment of a suspendable tent including a fly-sheet in a partially raised position in accordance with the present invention.

FIG. 7 is a rear view of a preferred embodiment of a suspendable tent including a fly-sheet in accordance with the present invention.

FIG. 8 is a front view of a preferred embodiment of a suspendable tent in accordance with the present invention with tent suspended from a tree.

FIG. 9a is an underneath view of a suspension system of a preferred embodiment of a suspendable tent in accordance with the present invention.

FIG. 9b is a perspective view of a suspension system of a preferred embodiment of a suspendable tent in accordance with the present invention.

FIG. 10 is a front view of a preferred embodiment of a suspendable tent in accordance with the present invention with a configurable flysheet in a raised (open) position creating a parasol shade overhead.

### DESCRIPTION OF THE PREFERRED EMBODIMENTS

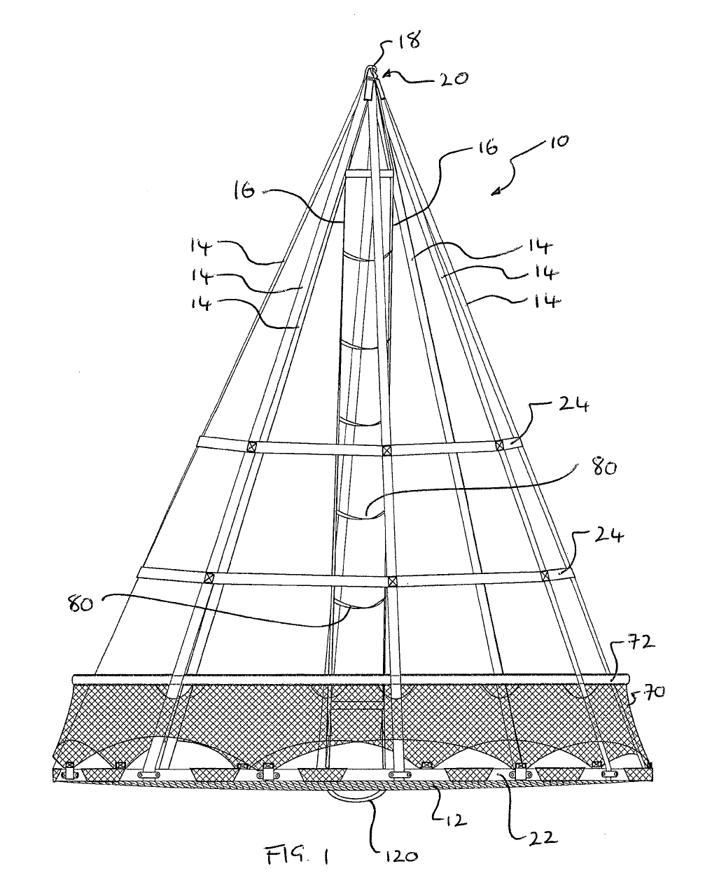

As shown in FIG. 1 to FIG. 9, a suspendable structure 10 in the form of a suspendable tent 10 comprises a flexible floor 12 and a network of suspension members 14, 16 for suspending the tent 10 from a suitable suspension point. The suspendable tent 10 is conical shaped with a polygonal (or circular) floor 12. The suspendable tent 10 provides a single or sole suspension member 18 which is located at an apex 20 of the suspendable tent 10.

The suspendable tent 10 provides a tensioned polygonal (or circular) flexible floor 12 which is retained within an outer rigid peripheral frame 22. The flexible floor 12 provides a supporting surface which is tensioned within the peripheral frame 22. In particular, the tensioned floor surface does not significantly bow under the weight of a person or persons being supported on the tensioned floor surface. For example, the tensioned floor surface doesn't bow much when a person is lying thereon but does bow slightly or a bit when a person is standing thereon although the floor surface is tensioned so that it doesn't bow much.

The peripheral floor frame 22 is supported from the suspension member 18 by a plurality of peripheral support members 14. These support members 14 comprise fabric or textile straps (section of webbing) which extend between the peripheral frame 22 and the suspension member 18 located at the apex 20 of the suspendable tent 10.

In order to further support the flexible floor 12 and help prevent against the deflection of the tensioned floor surface, the suspendable tent 10 comprises an internal or auxiliary support member 16. The internal support member 16 extends between a part of the tensioned floor 12 and the suspension member 18. In particular, the lower end of the internal support member 16 is secured to a floor anchoring position 90 comprising a part of the flexible floor spaced from the periphery of the tensioned floor 12. More specifically, the internal support member 16 is secured to the tensioned floor 12 at a generally central location.

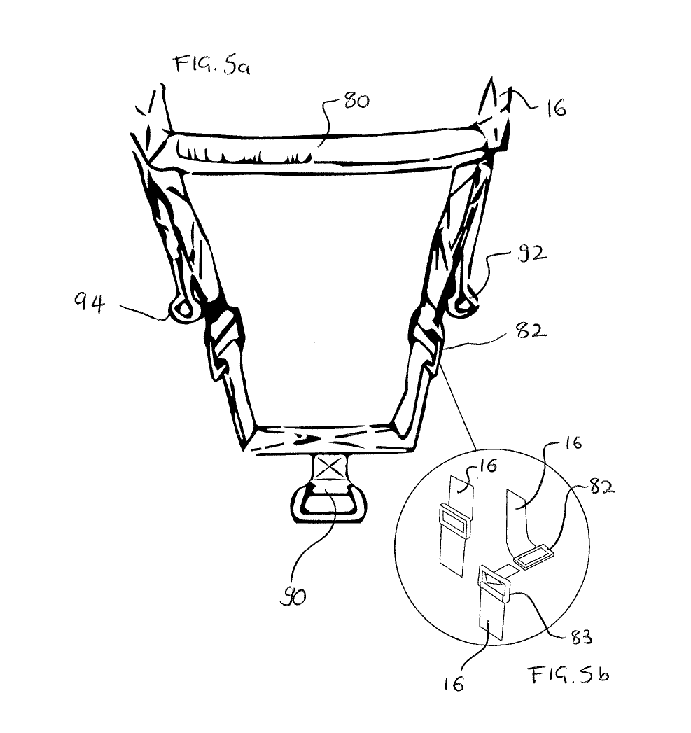

The height of the suspendable structure 10 is adjustable. The length of the internal support member 16 is adjustable with a buckling and tensioning system 82 for adjusting the floor level. For example, the internal support member 16 may comprise a buckle member 83 through which a further buckle member 82 can be engaged and the length of the internal support member 16 can be adjusted and held to set the (internal) height of the suspendable tent 10 (as shown in FIG. 5a and FIG. 5b). In addition, in some embodiments, the height of the peripheral support members 14 may also be adjustable by the peripheral support members 14 comprising such a system for also setting the length of these support members 14.

The internal support member 16 extends from a (lower) distal end to an (upper) proximal end. As mentioned above, the proximal end is secured to a (non edge) central part of the floor 12 at an anchoring position 90. It should be appreciated that in some embodiments, this anchoring position 90 will not be located at geometrical centre of the polygonal (or circular) floor 12 but will be at a position spaced from the periphery of the floor 12. In addition, the distal end may have more than one physical location where it is anchored, for example two spaced locations.

As shown in FIGS. 1, 3, 4, 5, 6 and 8 the internal support member 16 comprises two elongate spaced apart straps which extend upwardly from the floor 12 to the apex 20. The straps may be spaced apart by spreader bars used as the ladder steps. Accordingly, the suspension forces are arranged to be transferred vertically straight through the internal support member 16 to the floor 12. Alternative arrangements with the internal support 16 extending from a part of a peripheral support member 14 to the floor 12 would be subject to additional forces at the connecting portions and would not distribute the forces as uniformly or evenly. Such offset internal straps 16 may also create more obstructions within the internal space and would limit the usable space within the suspended tent 10.

The internal support member 16 comprises lateral support sections 80 which extend between the two spaced apart longitudinal straps. The lateral support sections 80 may comprise spreader bars and provide step portions to enable a user to climb up the internal support member 16. These effectively create a rope ladder within the tent 10. For example, such a rope ladder may be useful to help place or reposition a fly-sheet 100 or canopy over the structure 10. A person will also be able to climb to a more elevated position to reach other locations.

The upper (proximal) end of the internal support member 16 provides a single connecting point where the two longitudinal straps converge and meet. The two longitudinal straps may actually be provided by a single strap returning on itself. This also provides a single connecting point to secure the internal support member 16 to the suspension system located at the apex 18.

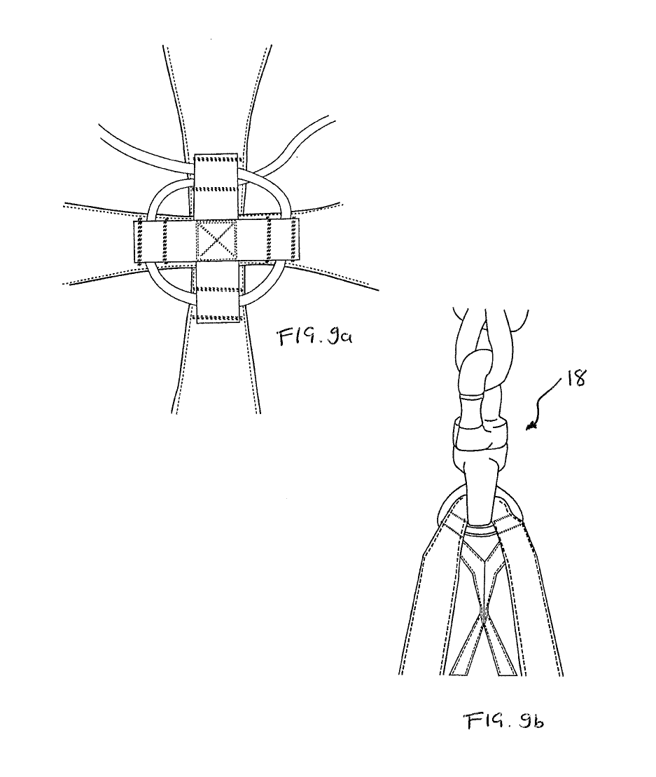

As shown in FIG. 9a and FIG. 9b, the upper (proximal) end of the internal support member 16 provides a single connecting point created by a single continuous longitudinal strap folded over and returning upon itself, which may be stitched together at the top to create a closed loop attachment point prior to splitting after the closed loop in to two separate tail ends. This also provides a single connecting point to secure the internal support member 16 to the suspension system located at the apex 18.

At the (lower) distal end, again the two longitudinal straps may converge towards connection points as shown in FIG. 5a and FIG. 5b. The lower distal ends may comprise tensioning buckle termination points stitched to the strap tail ends, creating an anchoring device 90 provided by attachment to the adjacent buckles that are attached to a strap sewn to the centre of the floor 12. This strap may comprise of a length of webbing that is stitched to a central part of the floor at the middle point of the webbing strap length itself. This creates two webbing tail ends through which the distal ends of the internal support member 16 can be secured, by way of the adjacent tensioning buckles 83, 83 fed or slotted through the webbing tail ends. Two further downward facing loops 92, 94 of a section of webbing are situated at each end of the internal support member 16 prior to the buckle termination points in FIG. 5a, FIG. 5b, these are for the attaching of the external ladder, by way of carabiners.

These downward facing webbing loops 92, 94 may provide connection points to enable a rope or webbing ladder to be attached for access purposes when the floor hatch 50 is in either the open or the closed position. This may be particularly beneficial if the suspended tent 10 is suspended relatively high in a tree and it is not possible for a person or persons to easily reach and access the suspended tent 10. Such an external access ladder may also be joined to an additional external access ladder by way of carabiners in order to increase its length and increase access height. It may also be removed or placed within the suspended tent 10 in order to restrict access to the tent 10.

In FIG. 1, a webbing loop 120 or handle section is provided on the (lower) opposing face of the floor 12. Upon construction of the peripheral frame 22, the webbing loop 120 may be used as a handle to turn or revolve the base floor structure, in order to assist in the equalisation of the tensioning of the mesh floor buckle straps 43, 45, which are situated around the (lower) opposing face of the outer peripheral frame 22. It may also be used to attach the base canopy cover 102 at its central point by way of a toggle and loop system to aid base canopy cover location and positioning, or may be used as a means of hanging storage of the base canopy cover 102 when not in use or may be partially removed to aid ventilation of the suspended tent 10.

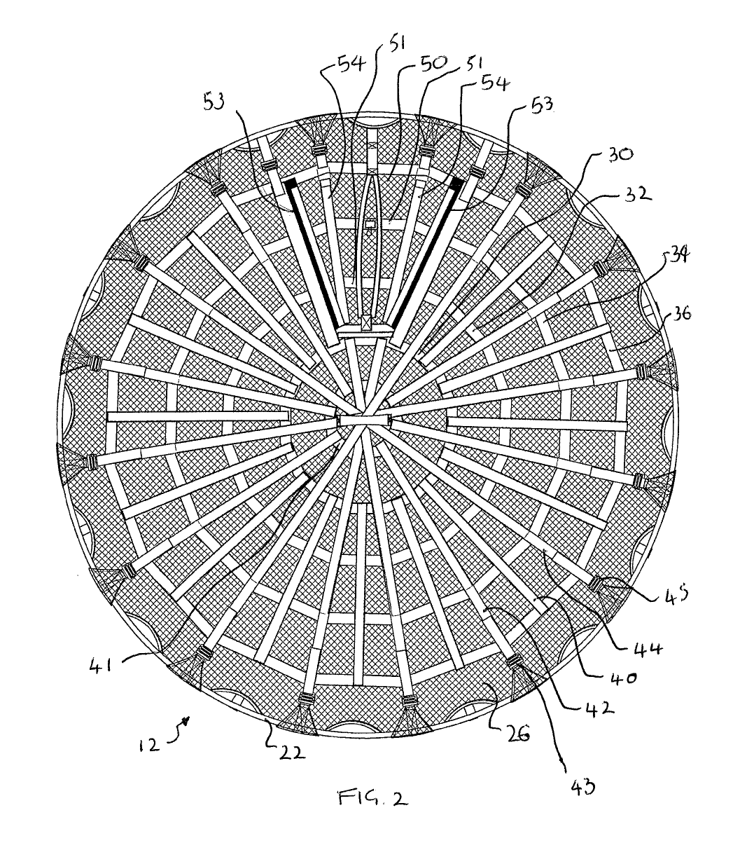

Alternatively, as shown in FIG. 1 and FIG. 2, the distal ends of both longitudinal members of the internal support 16 may be individually anchored at spaced apart locations on the floor 12. Again, these distal ends may be stitched to the floor 12. Furthermore, a section of webbing may also extend on the ground facing surface of the floor to provide a handle portion 120. This may enable other apparatus to be suspended from the tent 10.

To enter the suspended tent installed at height, a pair of external ladders (webbing or other material) may be attached (by way of carabiners or screw-link connectors) to the ladder-lugs 92, 94 located above the tensioning buckles 82, 83 at the distal (lower) ends of the internal support member 16, as shown in FIG. 5a.

The internal ladder-lug 92, 94 locations allow for exit or entry to and from the suspended tent 10 via the attached external ladders without undue stress or pressure upon or directly interfering with the angles or tensions of the mesh base/floor 12. This is particularly important when entering or exiting a suspended tent 10 already occupied by another user/person and or to avoid the potential hazards of loose/rolling or falling equipment.

This is achieved by locating the ladder-lug attachments 92, 94 at points (or point) situated suitably above the level of the mesh base/floor 12 and also attaching the external ladders independently of the mesh base/floor 12 and thereby taking the external ladders strain/loads directly through the internal support member 16 that is located/suspended above the height of the mesh base/floor 12.

The ladder-lugs 92, 94 internal location(s) may also allow for the external webbing ladders to be stored inboard of the suspended tent 10 for added security at night and/or when not in use.

This internal/external ladder configuration also allows for the suspended tent 10 to be entered entirely whilst a person is in the standing or upright position—allowing you to climb in and continue up and past the floor entry level to the top of the suspended tent—if necessary or required.

In an assembly with the ladder attached directly to the base/floor, the base/floor would be pulled directly downwards and towards the person (when the ladder is under load from a person climbing on it) and therefore pulls/slopes everyone and everything (equipment not tied down, etc.) that may already exist inside the structure. In particular, equipment etc will tend to move down and towards the base/floor hatch entry and directly in to the path of the person or other person climbing up or down the ladder.

The use of an internal support 16 member prevents the floor 12 from bowing significantly under the weight of a user(s). A flexible floor 12 which does not have the internal support member 16 coupled with the intrinsic tension within the floor surface 26 would tend to bow under the weight of a user. In particular, a floor on a suspended tent without such an internal (reinforcement) support may provide a hammock effect. Whilst this may be particularly suitable for some uses, such as providing temporary seating, the floor would not be suitable for prolonged use such as overnight sleeping.

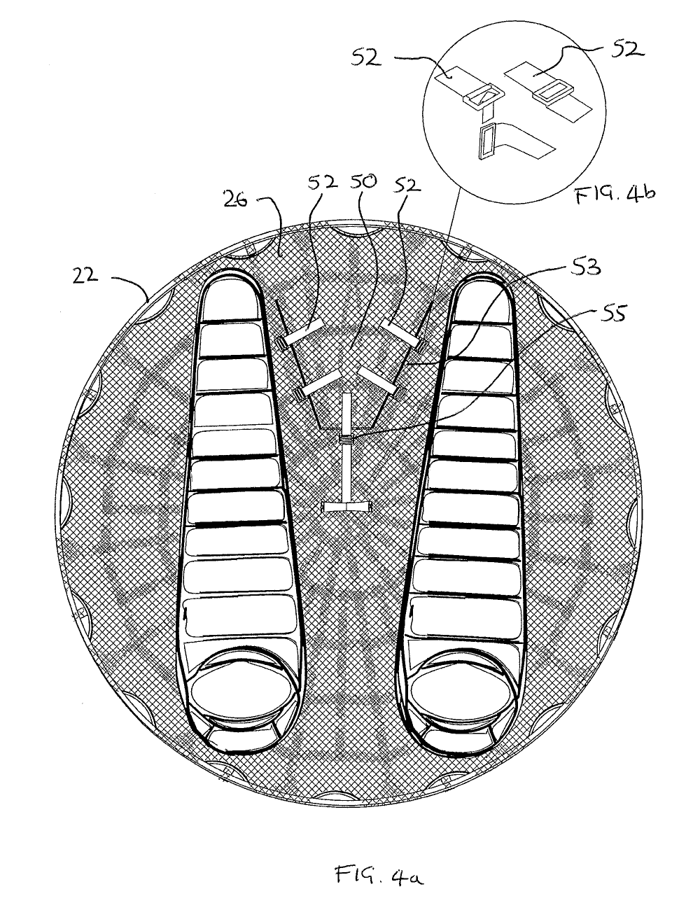

The present invention provides a floor structure 12 which can be tensioned to a relatively high degree and this also aids the integrity of the floor 12. For example, the flexible floor 12 of the present invention provides a network or matrix of webbing sections which is very strong, as shown in FIG. 2 and FIG. 4a. In addition, the webbing network can be tensioned evenly around the periphery through the use of the circular peripheral frame 12. A different shaped floor may be problematic when trying to avoid weak spots/locations within the tension of the floor.

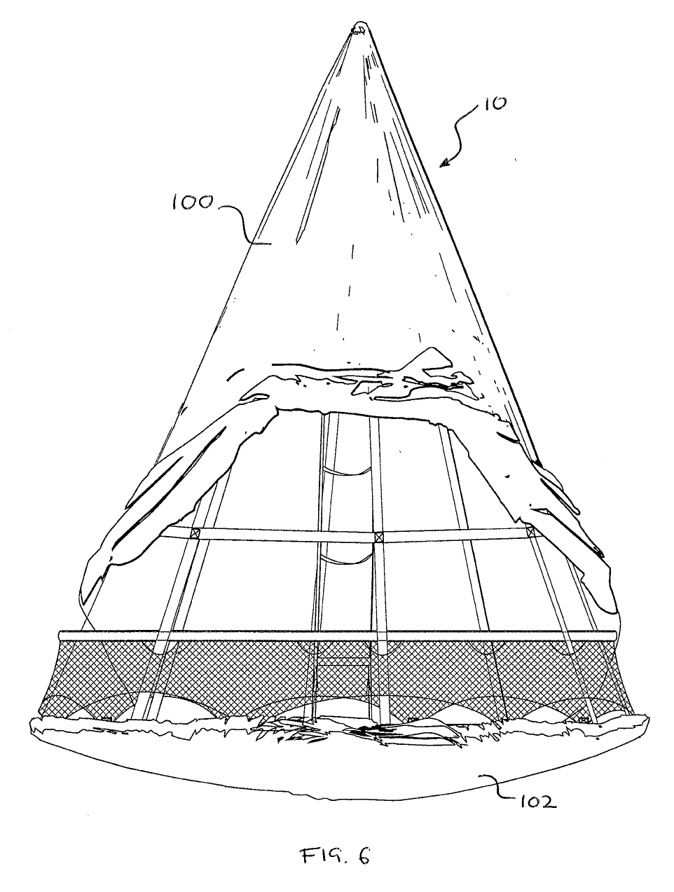

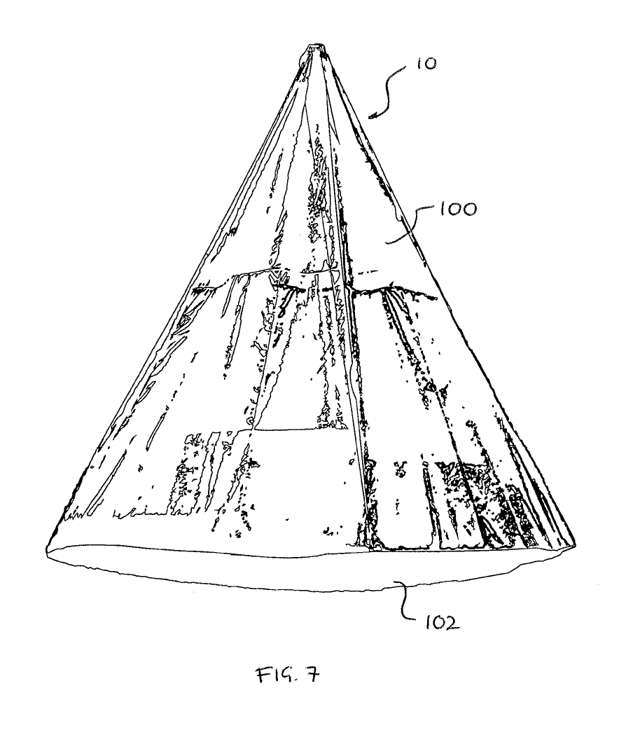

The suspendable tent 10 may comprise a fly-sheet 100 which may provide an outer wall for the conical tent 10, as shown in FIG. 6 and FIG. 7. The fly-sheet may comprise a standard tent fly-sheet 100 which is conical in shape to fit over the framework provided by the peripheral support members 14, reinforcement members 24 together with the peripheral frame 22. The fly-sheet 100 includes an inner toggle and loop retention system around the periphery and a centre front toggle and loop system for adjusting the height of a fly-sheet opening. The fly-sheet may comprise mosquito netting in order to provide protection from insects whilst a user is located within the tent 10. In some embodiments, the tent 10 may comprise an inner tent of mosquito netting and an outer tent 100 plus base covers 102 both standard textile and mosquito netting with a zipped hatch entry to provide a layered tent configuration. Alternatively, the tent 10 may be used without any fly-sheet to provide open sides being defined by the peripheral support members 14 and reinforcement members 24.

The tent 10 provides multiple configurations and a user can customise the tent 10 for the situation. For example, the fly sheet covers 100, 102 and camouflage can be selected based on the temperature and weather conditions of the location. Similarly, the internal height of the tent 10 and also the suspension height can be individually adjusted to take into account the occupancy level and the environmental conditions, for example the wind.

The reinforcement members 24 comprise lengths of a webbing or fabric and these extend around the periphery of the conical tent 10 at intermediate positions. In the preferred embodiment, there is provided a lower reinforcement ring and an upper reinforcement ring. These rings of the flexible reinforcement material 24 are spaced apart from each other and are effectively concentric with each other and the peripheral frame 22.

As shown in FIG. 1, the reinforcement members 24 are stitched at intersections with the peripheral support members 14. This creates a structural network to help evenly distribute the forces and to help maintain the overall shape of the structure 10. These interconnections also help prevent the structure from becoming tangled during storage and transportation, setting up and taking down etc. As it will be appreciated, a structure comprised of numerous non connecting straps may be liable to become tangled in between uses. These reinforcement members 24 also help support any fly-sheet 100 which may be included and placed over the top of the structure 10.

As shown in FIG. 2 and FIG. 4a, the floor 12 comprises a flooring surface 26 or floor covering which is effectively tensioned and/or stretched with the peripheral frame 22. The intrinsic strength of the floor 12 is primarily provided by a network of mesh and webbing. In particular, the floor 12 comprises five polygonal (or circular) webbing rings 30, 32, 34, 36, 41 which are concentrically arranged. The webbing matrix also comprises interconnecting sections of webbing 40 which extend between the inner webbing ring 30 and the outermost webbing ring 36.

The webbing matrix also comprises a first set of adjustable tensioning sections 42 which extend from a central ring 41 to an edge of the flooring surface 12. The webbing matrix also comprises a second set of adjustable tensioning sections 44 which extend diametrically across the polygonal (or circular) floor 12 and connect between opposing edge portions of the flooring surface 26.

The two sets of adjustable tensioning sections 42, 44 enable the tension of the flooring surface 26 to be manually adjusted to create the required tension. The adjustable tensioning straps 42, 44 may comprise a buckle mechanism 43, 45 through which the end of the strap 42, 44 is securely held. Such manually controlled buckles 43, 45 are commonly used to retain tension within a strap by preventing the end of the strap 42, 44 being pulled through the buckle 43, 45 by the tensile force placed on it. Furthermore, the buckle mechanism 43, 45 enables the strap 42, 44 to be easily tensioned by allowing the strap 42, 44 to be manually pulled through the buckle 43, 45 in a tensioning direction. Finally, the tension within the strap 42, 44 may be released or reduced by pivoting and/or placing the buckle 43, 45 at an angle relative to the direction of the strap 42, 44 to enable the tensile force to pull the strap 42, 44 through the buckle 43, 45.

The floor 12 provides a peripheral sleeve retaining enclosure into which the peripheral frame 22 is located. In particular, the peripheral frame 22 comprises a modular frame having 6 or 8 individual arcuate frame members or a number of arcuate frame members. The longitudinal ends of each arcuate frame member is arranged to be secured to an adjacent end of an adjacent arcuate frame member. Accordingly, the arcuate frame members are all connected and secured together to form a contiguous hoop or ring frame 22.

The arcuate frame members may comprise arcuate box sections and/or have a rectangular cross section or other profile. The vertical height of the frame members is arranged to be greater than the width (radial extent) since this helps to strengthen the peripheral frame 22. The preferred embodiment of the suspended tent 10 does not use cylindrical tubes for the arcuate frame members since these may not withstand and hold the significant tensile forces generated within the flooring surface 26.

The peripheral frame 22 is provided in a modular form to enable the suspendable tent 10 to be portable. For example, the peripheral frame may be dismantled to provide a kit which is comparable to a standard portable tent.

As mentioned above, the floor 12 provides a peripheral sleeve retaining enclosure into which the peripheral rigid frame 22 is located and the individual arcuate frame members can be slidably placed. For example, the sleeve relating enclosure provides a number of tensioned entrance regions into which the individual frame members can be inserted. In particular there may be the same number of entrance regions as there are frame members. One of the entrance regions may be more elongate in order to help the final connection to be made to complete the hooped/ring peripheral frame 22.

Whilst inserting the frame members and constructing the peripheral ring frame 22, the flooring surface 26 is maintained in a relatively slack (untensioned) state. This helps the frame members to be inserted and secured together. This also helps the final frame connection which is made to complete the frame ring which could otherwise be problematic.

The outer ends of the radial straps 42, 44 are secured to edges of the flooring surface 26. The radial straps 42, 44 are arranged to stretch and tension the flooring surface 26 within the circular peripheral frame 22. The flooring surface 26 comprises a polygonal (or circular) flooring material which has outwardly extending tapered sections having the tensioning buckle 43, 45 secured at the tips thereof. The tapering sections are arranged to be pulled over and around the frame 22 such that the tensioning straps 42, 44 locate on one side of the peripheral frame 22 and the actual flooring surface 26 locates on the second side of the peripheral frame 22. In this arrangement, the tensioning straps 42, 44 are pulled inwardly from below the floor and this effectively shortens the length of the radial (diametrical) tensioning straps 42, 44. The ends of these straps 42, 44 are secured to the outer edges of the flooring surface 26 and this thereby pulls the edges of the flooring surface 26 towards each other on the lower side of the peripheral frame 22 which thereby causes the flooring surface 26 to be stretched and tensioned. As described above, the flooring surface 26 overlaps the peripheral frame 22 and is stretched over the peripheral frame 22.

The use of the manually adjustable tensioning straps 42, 44 enables the user to place the flooring surface 26 under significant tension. The flooring arrangement together with the internal support member 16 thereby prevents or inhibits the floor from becoming bowed and providing a hammock effect.

The flooring surface 26 comprises an open material or mesh. This creates an airy internal environment. The use of a mesh may also prevent access to insects whilst still allowing the atmosphere to freely circulate which may be useful in warm/hot climates. A textile base cover 102 (shown in FIG. 6 and FIG. 7) may provide protection against the cold, the mesh allows air circulation and provides part of a sweat management system and the mosquito net covers stops the insects. In alternative arrangements, the floor may comprise a closed fabric surface to try and protect the internal atmosphere and provide more of a shelter which may be more relevant in cold climates.

As shown in FIG. 2, FIG. 4a and FIG. 4b, the suspendable tent 10 is provided with an access or entrance region 50 within the floor 12. Accordingly, a user will enter the tent 10 from below. As mentioned above, if required an access rope ladder or the like may be used to enable a user to climb up and into the suspended tent 10.

The entrance region 50 comprises a section of the floor 12 which can be at least partially disconnected to provide a passageway through the floor 12. For example, straps/buckles 52 or other closing mechanism is provided to create an opening flap within the floor 12 and to part the floor at the created edges 53. The buckles 52 or other closing mechanism also enables the tension within the floor 12 to be maintained when the flap is closed.

As shown in FIG. 4a, the door opening 50 may be defined within a partial sector area of the floor, for example trapezoid and/or an annular sector. The door opening 50 may have four lateral buckle portions 52 located along the two radially extending sides 53. The outer annular side may be integral with the floor 12 and flooring surface 26. The inner central edge of the door opening may comprise a further buckle portion 55 or other closing mechanism to complete the securement within the opening aperture 50 in the floor 26.

In order to access the tent 10, the buckles 53, 55 (or other securement mechanism) are used to enable the flap 50 to fall away from the opening aperture whilst the flap 50 remains attached along the outer annular edge. Conversely, buckles 53, 55 are operated to close the opening and to provide a load bearing portion of the floor 12.

The door flap 50 includes two radial straps 54 (shown in FIG. 2). These radial straps 54 may both be adjustable to set the tension in the straps 54. The door flap 50 may also include two arcuate or linear sections of webbing 51 to complete the webbing polygons (rings) 32, 34 and to transfer the forces. These webbing polygons (rings) 32, 34 are affectively contiguous tension webbing polygons (rings) 32, 34. The outermost webbing polygon (ring) of the floor 36 is arranged to coincide with the outer secured section of the door opening such that the outermost tension polygon (ring) 36 is a continuous section of webbing rather than a contiguous polygon (ring). Similarly, the inner webbing polygon (ring) 30 coincides with the inner securing/closing edge of the door flap 50. Again, this enables the inner webbing polygon (ring) 30 to be a continuous section of webbing rather than a contiguous polygon (ring).

The bottom cover 102 (see FIG. 6 and FIG. 7) may be provided with a section of mosquito netting to provide an inner flap and a section of material/fabric to provide an outer flap. This provides a layered door opening.

The suspendable tent 10 comprises lateral support (reinforcement) members 24 which extend around the periphery of the suspendable tent 10. The suspendable tent 10 comprises two lateral support members 24. The lateral support members 24 comprise sections of webbing which extend around the periphery of the suspendable tent 10 in a spaced apart configuration. The lateral support members 24 are concentric support members and these are spaced apart along the outer conical surface or outer conical periphery of the suspendable tent 10. These lateral support members 24 are stitched at intersections to the peripheral support members 14. The lateral support (reinforcement) members may comprise a (rigid) retaining frame constructed of a number of sections. For example the frame may be similar to the peripheral support frame 22 or retaining frame 72 in that a number of rigid poles may be secured together to form a hoop or ring.

As shown in FIG. 6 and FIG. 7, the suspendable tent 10 may have a fly-sheet 100 placed over the top to provide more of a conventional tent like appearance. The fly-sheet 100 may comprise a fly-sheet of mosquito netting to protect the internal environment from insects etc. Alternatively or in addition, a substantially closed fly-sheet 100 of a canvas or other material (or fabric) may be used to provide further protection against the wind, rain and weather etc. In some embodiments the fly-sheet 100 comprises a three dimensional camouflage fly-sheet. This may provide an alternative fly-sheet which may also protect against insects. The three dimensional camouflage fly sheet may be used in combination with a mosquito net.

The fly-sheet 100 may be substantially conical in shape and located over the frame provided by the suspendable structure 10. The lower edge of the fly-sheet may be secured to the peripheral frame member 22 and the other end may be secured around apex 20. For example, the fly-sheet 100 may have a central opening which also includes an adjustable waterproof sealing ring in an apex through which the suspension mechanism 18 may project. The fly-sheet 100 may provide windows which may be opened. The main fly-sheet 100 and/or the base fly-sheet 102 may provide windows which may be opened.

As shown in FIG. 9a and FIG. 9b, the preferred embodiment of the present invention comprises a purely textile suspension means. As opposed to a suspended tent which utilise a metal component at the top to create a hanging/suspension point, the nosecone of the suspended tent (located at the proximal end of the internal support member) may be an ‘all-textile’ solution, and may be constructed of two warp and two weft directional webbing fabric lengths intersecting each other intermittently (to reduce height differentiation) at an angle 90° at their centre points. This intersection may also contain or attach to a knotted rope, swivel, carabiner or screw-link device.

In the middle of this webbing intersection and attached to the underside may be one pair of shorter webbing lengths (or similar) that may cross each other at an angle of 90° and which may also be attached in the centre as well as at the outer ends in order to create channels of a suitable width that may accept a draw-able length of cord like material at the outer ends, which may knot/tie together or lock-off to create a fixed length and/or a tensioned closed loop or ring, in order to contain/restrain or attach a knotted rope, swivel, carabiner or screw-link device.

The suspended tent 10 comprises a retaining section 70 (shielding section or shroud portion) which extends around a lower section of the tent 10, as shown FIGS. 1, 3, 6 and 8. This shroud 70 comprises a section of mesh or material which is secured around the peripheral wall/side of the conical structure. The retaining section 70 is arranged to prevent users and/or articles/objects from inadvertently falling from the suspended tent 10. In addition, the retaining section 70 provides a backrest for users which may be sitting within the suspended tent 10.

An upper edge of the retaining section 70 is secured to a retaining frame 72. A lower edge of the retaining section 70 is secured to the peripheral frame 22. In use, the material of the retaining section 70 is stretched between the axially spaced apart retaining frame 72 and the peripheral frame 22. The material of the retaining section 70 thereby provides an inwardly tapered cylindrical wall around a lower portion of the suspended tent 10. The lower edge of the material of the retaining section 70 is only connected to the peripheral frame 22 at discrete positions. This connection may be through an adjustable toggle system to enable the tension within the material of the retaining section 70 to be adjusted. As shown in FIG. 1, this leaves open (generally segmental shaped) areas around the lower side of the suspended tent 10.

The retaining frame 72 comprises a rigid frame in the form of a hoop or ring. As with the peripheral frame, the retaining frame may comprises a number (3, 4, 5, 6, 7, 8 etc.) of individual frame members which are connected together to form a contiguous rigid ring frame 72. The retaining frame 72 may locate within a sleeve enclosure which is defined around the upper edge of the material of the retaining section 70. This sleeve enclosure and the material of the retaining section 70 may be stitched at intersections to the peripheral support straps 14.

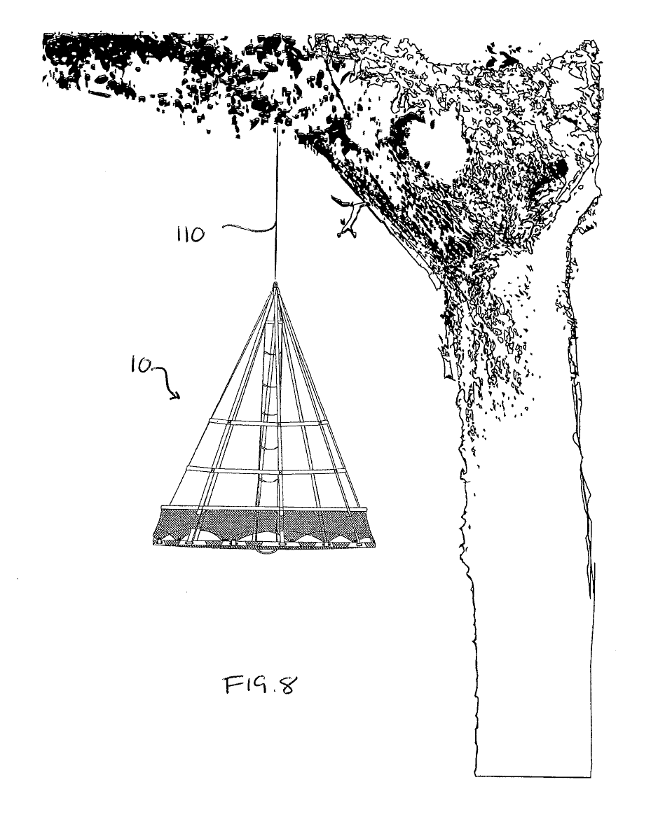

The suspension means provides a single suspension point which solely supports and suspends the tent 10. For example, the suspended tent 10 may be solely supported at a single point from a tree, as shown in FIG. 8, to enable the tent 10 to pivot in any direction about this point. The flooring 12 is intrinsically tensioned and an internal support strap 16 prevents the floor 12 from sagging. Accordingly, the present invention provides a suspendable tent 10 which does not require any guy ropes or other extrinsically secured tensioning and/or supporting and/or stabilising devices. The sole weight of the structure is entirely transferred through the single suspension point. If required, an auxiliary safety strap can be used to provide a second independent suspension point in case of failure of the first suspension point.

The single suspension point provides an omni-pendular motion that aids sleeping and is easy to set up from the ground without having to climb another structure (e.g. the suspending tree or an adjacent tree) and provides easily adjustable hanging heights (e.g. it can be lowered in high winds).

The suspension means comprises a suspension member 18 in the form of a webbing loop. The suspension mechanism may incorporate a swivel mechanism to enable the suspendable tent 10 to rotate around its central longitudinal axis.

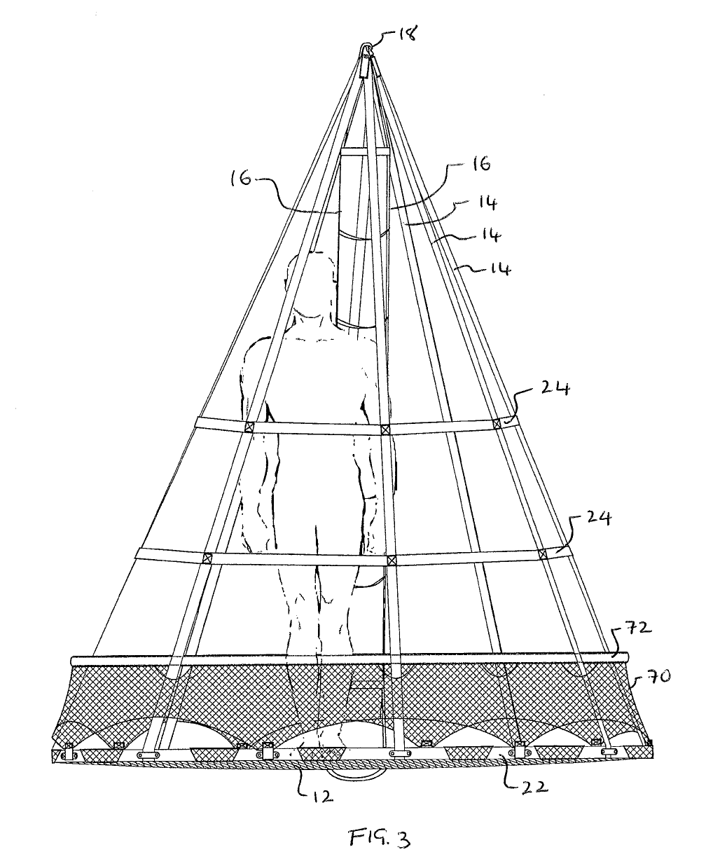

The suspendable tent 10 may have a height in the region of 2.5 to 3 metres which would enable a user/users to stand within the structure 10 (see FIG. 3). The diameter of the floor 12 may be in the region of 2 to 2.5 metres which would enable a user/users to lie fully flat on the floor surface 12 (see FIG. 4a).

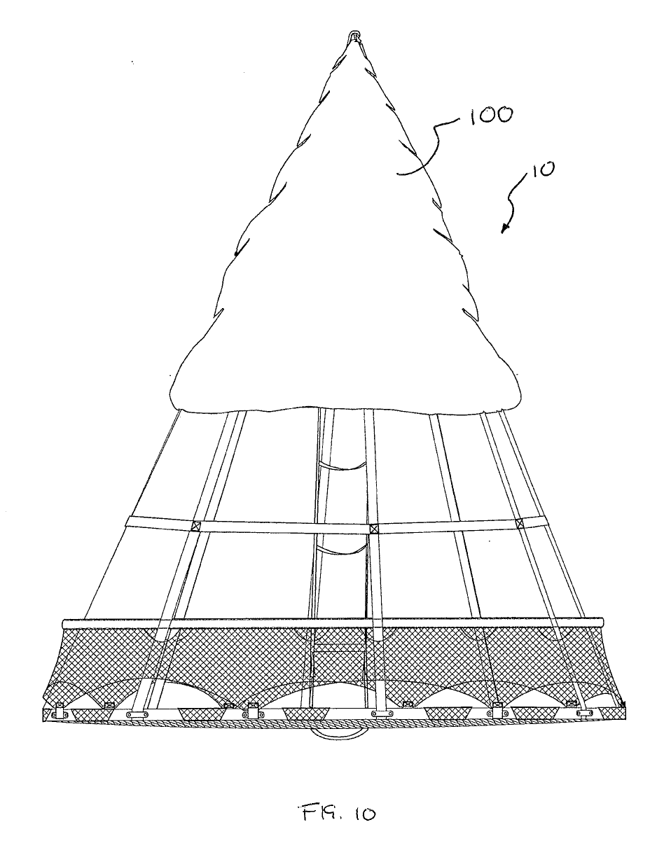

As shown in FIG. 10, the flysheet may also be raised to a fully open position and secured by a shock cord retention system. This configuration creates a layered parasol shade overhead.

The present invention provides numerous differences over current suspendable structures. For example, the present invention provides a structure which can be purchased and used without a tent covering and so provides a suspendable platform (or sensory motion platform), which also offers by way of accessories, various separate tent style covers e.g. fly-sheet, mosquito net, 3D camouflage netting.

The suspendable structure comprises four crossed straps that create eight ends, to connect to a main ring. The suspendable structure 10 does not include a trampoline type floor but is a hybrid of a warp knitted mesh fabric in conjunction with a stitched narrow woven webbing attached by way of open loop straps which are closed and fully adjustable through the use of rated aluminium safety buckles for tensioning—without the use of springs or elastic loops. The suspendable structure 10 includes two completely separate units (base structure and fly-sheet), which are not sewn together to give modularity to the suspendable platform/structure.

The peripheral frame of the suspendable structure 10 comes in eight sections providing an even more compact product. The suspendable structure 10 is constructed of aluminium box section and warp knitted polyester fabric.

One particular feature of the present invention is the ladder system which is not attached or load bearing off of the base or side structure but loads separately and independently to the base or side structure and so aid stability when accessing the structure.

The centrally located internal support member allows two people to sleep next to each other without rolling to the centre. The suspendable structure 10 supports a maximum weight of 250 Kg.

The suspendable structure 10 includes a rigid component (a tubular aluminium backrest ring) above the rim level, and a mesh safety panel all around the structure—which rises up from the base ring and attaches to the backrest ring. The main structure door opening is secured by way of safety buckles & webbing making it load bearing when secured in the closed position. The suspendable structure 10 is provided in a separate wearable kit-bag and is not sewn-in to the structure.

It may be possible to have more of a frustum cone in shape but the main embodiment of the present invention is more conical and does not stop short of the top of the structure but actually extends over the top of the structure creating a waterproof sealing ring and not a large open aperture.

1. A suspendable structure comprising;
a flexible floor for supporting a person thereon spaced from a ground surface;
a suspension member to support the suspendable structure vertically spaced apart from the ground surface;
a peripheral support frame arranged around the flexible floor, the flexible floor being secured within the peripheral support frame and wherein the peripheral support frame is arranged to maintain tension within the flexible floor;
a plurality of flexible peripheral support members extending between the peripheral support frame and the suspension member;
the flexible floor providing an entrance region through which a person can access the suspendable structure;
an internal support member extending between the suspension member and a floor anchoring position on the flexible floor; and
wherein the floor anchoring position is located on the flexible floor at a location spaced inwardly from the periphery of the flexible floor.

2. A suspendable structure according to claim 1 in which the suspendable structure comprises a suspendable tent.

3. A suspendable structure according to claim 1 in which the suspendable structure is portable within a backpack by a single person whilst in a storage or transportable configuration.

4. A suspendable structure according to claim 1 in which the suspension member provides a single suspendable location for the suspendable structure and the suspendable structure is solely supported by the suspension member.

5. A suspendable structure according to claim 1 in which, in use, the suspendable structure is substantially conical in shape and, in use, the suspendable structure is suspended from the apex of the cone.

6. A suspendable structure according to claim 1 in which the peripheral support members converge towards each other upwardly from the peripheral support frame towards the suspension member and in which each peripheral support member comprises a proximal end secured to the suspension member and a distal end secured to the peripheral support frame.

7. A suspendable structure according to claim 1 in which the peripheral support frame comprises a rigid peripheral support frame which comprise a plurality of peripheral support poles.

8. A suspendable structure according to claim 1 in which the floor anchoring position is substantially centrally located on the flexible floor.

9. A suspendable structure according to claim 1 in which the internal support member comprises a plurality of parallel flexible sections of material and in which the parallel sections are connected together by lateral sections and the lateral sections provide step portions to create a ladder for a person to climb on.

10. A suspendable structure according to claim 1 in which the floor comprises a webbing matrix comprising a plurality of sections of webbing and wherein the webbing matrix comprises a plurality of sections of webbing which are tensioned by tensioning adjustment means.

11. A suspendable structure according to claim 10 in which the webbing matrix comprises a plurality of concentric lengths of webbing in varying circumferences or diameters within the flexible floor.

12. A suspendable structure according to claim 10 in which the webbing matrix comprises a plurality of radial sections of webbing which extend between an inner polygonal (or circular) section of webbing and an outer polygonal (or circular) section of webbing and these radial sections of webbing connect each individual polygonal (or circular) webbing section.

13. A suspendable structure according to claim 10 in which the webbing matrix comprises a number of adjustable webbing sections extending radially across a part of the radius of the floor and wherein proximal ends of these adjustable webbing sections are connected to an inner polygonal (or circular) section of webbing and distal ends of these adjustable webbing sections are connected to a part of a flooring surface.

14. A suspendable structure according to claim 10 in which the webbing matrix comprises a number of adjustable webbing sections extending across the diameter of the floor and wherein proximal ends and distal ends of these adjustable lengths of webbing are connected to a part of a flooring surface.

15. A suspendable structure according to claim 1 in which the flexible floor comprises an entrance region comprising a door to enable a person to enter and exit the suspendable structure and wherein the flexible door is located offset from the centre of the flexible floor.

16. A suspendable structure according to claim 15 in which the door forms a part of the flexible floor and wherein the door provides a load bearing portion of the floor such that the floor provides a single contiguous tensioned surface when the door is in a closed configuration.

17. A suspendable structure according to claim 1 in which a separation distance between the suspension member and the flexible floor is adjusted through the adjustment of the length of the internal support member and, in which, the suspendable tent is reconfigurable to provide a suspendable tent having a variety of heights.

18. A suspendable structure according to claim 1 in which the suspendable structure comprises a fly-sheet to create an outer wall for the suspendable structure, and in which the suspendable structure comprises a separate floor fly-sheet with an entry hatch.

19. A suspendable structure according to claim 1 in which the suspendable structure comprises a flysheet which is configurable between a closed position and an open position and in which the flysheet is arranged to be raised to a fully open position and secured by securement means in the form of a shock cord retention system and wherein the flysheet creates a layered parasol shade overhead.

20. A method of providing a suspended structure comprising suspending a suspendable structure, the suspendable structure comprising;
a flexible floor for supporting a person thereon spaced from a ground surface;
suspension member to support the suspendable structure vertically spaced apart from the ground surface;
a peripheral support frame arranged around the flexible floor, the flexible floor being secured within the peripheral support frame and wherein the peripheral support frame is arranged to maintain tension within the flexible floor;
a plurality of flexible peripheral support members extending between the peripheral support frame and the suspension member;
the flexible floor providing an entrance region through which a person can access the suspendable structure;
an internal support member extending between the suspension member and a floor anchoring position on the flexible floor; and
wherein the floor anchoring position is located on the flexible floor at a location spaced inwardly from the periphery of the flexible floor.
